(19) United States
(12) Patent Application Publication
(10) Pub. No.: US 2022/0051227 A1
(43) Pub. Date: Feb. 17, 2022

(54) PERSONAL CONTACTLESS-TIP-REGISTERING DEVICE

(71) Applicant: PC Rescue Squad Ltd., Worcester Park (GB)

(72) Inventor: Saif Abdul-Rasul, Worcester Park (GB)

(73) Assignee: PC Rescue Squad Ltd., Worcester Park (GB)

(21) Appl. No.: 17/399,649

(22) Filed: Aug. 11, 2021

(30) Foreign Application Priority Data
Aug. 11, 2020 (GB) 2012458.2

(51) Int. Cl. G06Q 20/32; G06Q 20/10

(52) U.S. Cl. CPC G06Q 20/3278; G06Q 20/102; G06Q 20/3223; G06Q 20/3255

(57) ABSTRACT

A personal contactless-tip-registering device 10 for registering a contactless tip via a contactless-payment device. The device includes a body 12, a user fastener 15, an on-board power source 20, an electronic wireless reader 22, a processor 24, a data storage device 26, a wireless transmitter 28, and an indicator 14 on the body 12. The data storage device 26 includes pre-set and non-adjustable tip data which specifies a pre-set and non-adjustable tip amount, and the indicator 14 indicates the pre-set tip amount

This application claims foreign priority to United Kingdom Patent Application No. GB2012458.2 filed on Aug. 11, 2020, the disclosure of which is hereby incorporated by reference in its entirety for all purposes.

The present invention relates to a personal contactless-tip-registering device. The invention further relates to a personal tip-registration system, a method of directly tipping a service provider via a contactless payment, a service payment and tipping apparatus, a service payment and tipping system, and a method of directly tipping a service provider via a contactless payment and directly paying an employer.

Service providers, such as waiters, taxi drivers, barbers or hairdressers, may be provided a tip or gratuity by a customer. A tip or gratuity is typically provided in addition to a payment for the service from the customer. If the service provider is an employee or agent acting for an employer or principal, the payment for the service is typically intended to be ultimately received by the employer, and the tip is typically intended to be ultimately received by the employee.

Previously, service providers were nearly always tipped in cash. Increasingly, customers do not carry cash and instead pay for services via payment devices, such as credit or debit cards, or via electronic devices such as mobile telephones with a contactless payment capability.

When paying for a service using a payment device, for example on a typical card payment terminal, a user may be invited to enter an additional amount of payment to be given as a tip to the service provider employee as part of the same payment transaction.

However, such an arrangement requires the employer to establish a system to log and transfer the tips to the employees, for example as part of their pay, which may create an administrative burden. Additionally, some customers may be concerned that the tip, or a portion thereof, may instead be taken by the employer and may ultimately not be received by the employee.

Furthermore, it may be challenging or awkward for some customers to enter the tip amount onto the card payment terminal. For example, if the instructions on the card payment terminal are not clear then the customer may find it difficult to enter the tip amount. Additionally or alternatively, the customer may be required to inform the service provider of the tip amount so that the service provider may input the tip amount. The customer and service provider may find this exchange socially awkward.

As such, it would be desirable to be provide a way of quickly, conveniently and directly tipping a service provider employee using a payment device.

The present invention seeks to provide a solution to these problems.

According to a first aspect of the invention there is provided a personal contactless-tip-registering device for registering a contactless tip via a contactless-payment device, the tip-registering device comprising: a body; a user fastener at or adjacent to the body for releasably attaching the tip-registering device to a service provider; an on-board power source at or in the body; an electronic wireless reader at or in the body for wirelessly reading contactless-payment-device data from the contactless payment device; a processor at or in the body; a data storage device at or in the body including pre-set and non-adjustable tip data which specifies a pre-set and non-adjustable tip amount to be paid by the contactless payment device; a wireless transmitter at or in the body for transmitting tip data and contactless-payment-device data to an external payment processing system; and an indicator on the body which indicates the pre-set tip amount; the power source configured to power the electronic wireless reader, processor, data storage device, and wireless transmitter, and the processor connected to the electronic wireless reader, data storage device and wireless transmitter so that when contactless-payment-device data is read by the electronic wireless reader, the transmitter transmits the tip data and the contactless-payment-device data to the external payment processing system.

A contactless payment system is a quick and efficient way for a customer to provide a tip since, in many countries worldwide, contactless payments can be taken without verification. Therefore, a payment can be taken without the entering of a personal identification number or provision of a signature. This may be due to contactless payments conventionally being limited or capped to relatively small amounts.

The tip-registering device may be considered to be personal since it is portable, and so may be carried on a service provider's person, and/or since it can be linked to a service provider's personal bank account.

An on-board power source allows for the device to be portable, and thus for a service provider to carry the device to the customer who is being served.

A user fastener or other attachment means allows for the device to be conveniently carried by the service provider at all times, for example on a lanyard, without requiring the use of their hands.

The tip amount being pre-set prevents or limits a requirement for the customer to decide upon and input a tip amount, which may increase the speed of, and reduce awkwardness in, the interaction between customer and service provider. Increasing the speed at which a tip may be provided may allow for the service provider to serve more customers.

The tip amount being non-adjustable, for example via the use of read-only memory, prevents or limits tampering with the device and so the customer may be reassured that the amount which will be debited from their payment device is the amount which is displayed by the indicator.

The device being separate from a device which receives payment may allow for linking of the tipping device to the service provider's bank account. This may reduce an administrative burden on the employer to transfer tips, and may give confidence to customers that the service provider will receive the tip.

Whilst described as a tip registering device, the device may also be understood to be a tip receiving or tip reading device.

Preferably, the device may not comprise an electrical screen, microphone, or a button. More preferably, the device may not comprise any of an electrical screen, microphone, and/or a button. Not including the aforementioned components increases the durability of the device as well as reducing the power requirements.

Advantageously, the indicator may be non-electrical. A non-electrical indicator may be easier to read, for example, in bright light conditions as well as reducing the power requirement of the device.

Beneficially, the indicator may be embossed text. Use of embossed text may provide for a more durable indicator, for example as compared to printed text alone, since the embossing may be visible even if colouring fades.

In a preferable embodiment, the indicator may be text and a text height may be greater than or equal to 25% of a diameter of the body. Large text allows for the indicator to be readily visible to the customer.

Optionally, the transmitter may be for communicating with a WiFi® network. This allows for the device to communicate with a local WiFi® access point, which may be convenient since service establishments typically have WiFi® networks. Utilising a pre-existing WiFi® network may reduce a running cost of the device, as compared to using a mobile telephone network, for example.

Additionally or alternatively, the transmitter may be for communicating with a mobile telephone network. This allows for the device to be used when a WiFi® network is not available.

Preferably, the user fastener may comprise a hole for connecting a clip or hook therethrough. This may allow for the device to be conveniently attached to a lanyard, belt, or other article of clothing. Whilst described as a user fastener, it will be appreciated that the device would not directly attach to the user. Additionally or alternatively, the device may not attach to a user, and may in fact attach to a key chain or other common items typically held by a person.

Advantageously, the user fastener may comprise a closed loop.

Beneficially, the body may have a diameter of less than or equal to 100 mm. A small size increases the portability of the device.

In a preferable embodiment, the body may be planar or substantially planar. A planar or flat device may allow the device to sit or hang more conveniently or comfortably against the user's body.

Additionally, the body may have a thickness of less than or equal to 10 mm. A thin device may also allow the device to sit or hang more conveniently or comfortably against the user's body.

Optionally, the body may be hexagonal.

Advantageously, the pre-set tip amount may be 5 GBP, 5 USD, 5 EUR or 50 RMB. Such amounts may be a convenient or typical tipping amount.

Preferably, the on-board power supply may be a rechargeable battery. A rechargeable battery may allow for repeated use.

Optionally, the device may comprise a receiver of a positioning system, the data storage device including location data, the processor transmitting contactless-payment-device data only if the receiver of the positioning system determines the location of the device is according to the location data. This may only allow the device to be used in one locality, for example, to prevent or limit unauthorised use of the device in other establishments. This may prevent or limit customers becoming deceived.

According to a second aspect of the invention, there is provided a personal tip-registration system for registering a tip for a service provider, the system comprising: a personal contactless-tip-registering device according to the first aspect of the invention; an external payment processing system communicatively connected to the personal contactless-tip-registering device; and a personal bank account belonging to the service provider and communicative with the external payment processing system; the external payment processing system configured to deposit at least one tip amount registered by the personal contactless-tip-registering device directly into the personal bank account.

In this way, the tip which is registered is received into the service provider or employee's bank account, rather than being required to be transferred from the employer's bank account.

According to a third aspect of the invention, there is provided a method of directly tipping a service provider via a contactless payment, the method comprising the steps of: providing a service provider with a personal contactless-tip-registering device according to a first aspect of the invention and attaching the tip-registering device to the service provider; the service provider presenting the tip-registering device to a customer of the service provider, the customer having a contactless payment device; the tip-registering device reading contactless-payment-device data from the contactless payment device and transmitting the contactless-payment-device data and pre-set tip data which specifies a pre-set tip amount to an external payment processing system; the external payment processing system directly depositing the pre-set tip amount in a bank account belonging to the service provider.

Whilst the tip-registering device is described as being attached to the service provider, it will be appreciated that this may not be the case.

According to a fourth aspect of the invention, there is provided a service payment and tipping apparatus for registering payment directly to an employer and registering a contactless tip directly to an employee, the apparatus comprising: a personal contactless-tip-registering device according to a first aspect of the invention; a payment-registering device including a further body, a further electronic reader at or in the body for reading payment-device data from a payment device; a further processor at or in the body; a further data storage device at or in the body for receiving payment data which specifies a payment amount to be paid by the payment device; at least one of a wired communication connection and a wireless transmitter at or in the body for communicating payment data and payment-device data to an external payment processing system; the further processor connected to the further electronic reader and said at least one of a wired communication connection and a wireless transmitter so that when payment-device data is read by the electronic reader, said at least one of a wired communication connection and a wireless transmitter transmits the payment data and the payment-device data to the external payment processing system.

As such, two devices are provided which can each take payment from a payment device or an electronic payment device. Therefore, the service payment and tip are easily segregated, which provides confidence to the customer that the employee will receive the tip.

According to a fifth aspect of the invention, there is provided a service payment and tipping system for registering payment directly to an employer and registering a contactless tip directly to an employee, the system comprising: the service payment and tipping apparatus according to a fourth aspect of the invention; an external payment processing system communicatively connected to the personal contactless-tip-registering device; the payment-registering device communicatively connected to the or another external payment processing system; a personal bank account belonging to the employee and communicative with the external payment processing system; a bank account belonging to the employer and communicative with said the or another external payment processing system; the external payment processing system configured to deposit at least one tip amount registered by the personal contactless-tip-registering device directly into the personal bank account; and said the or another external payment processing system configured to deposit at least one payment amount registered by the payment-registering device directly into the company bank account.

According to a sixth aspect of the invention, there is provided a method of directly tipping a service provider via a contactless payment and directly paying an employer, the method comprising the steps of: providing a service provider with the service payment and tipping apparatus according to the fourth aspect of the invention and attaching the tip-registering device to the employee; the employee presenting the payment-registering device to a customer of the employee, the customer having a payment device; the payment-registering device reading payment-device data from the payment device and communicating the payment-device data and payment data which specifies a payment amount to an external payment processing system; the external payment processing system directly depositing the payment amount in a bank account belonging to the employer; the service provider presenting the tip-registering device to a customer of the service provider, the payment device being contactless or the customer having a contactless payment device; the tip-registering device reading contactless-payment-device data from the contactless payment device and transmitting the contactless-payment-device data and pre-set tip data which specifies a pre-set tip amount to an external payment processing system; and the external payment processing system directly depositing the pre-set tip amount in a bank account belonging to the service provider.

According to a seventh aspect of the invention, there is provided a personal tip registration system comprising a plurality of the personal contactless-tip-registering devices according to the first aspect of the invention, each of the personal contactless-tip-registering devices having a different pre-set tip amount.

The invention will now be more particularly described, by way of example only, with reference to the accompanying drawings, in which:

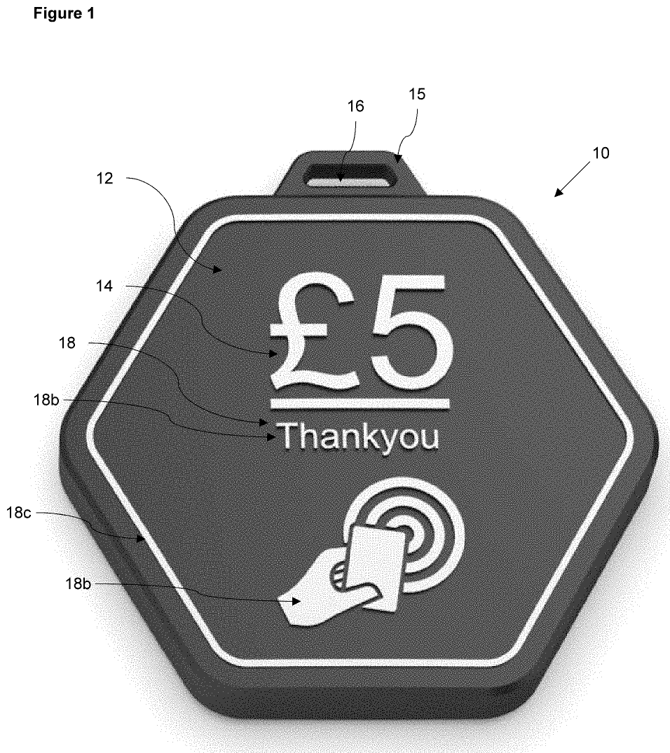

FIG. 1 shows a front view of a personal contactless-tip-registering device according to a first aspect of the invention;

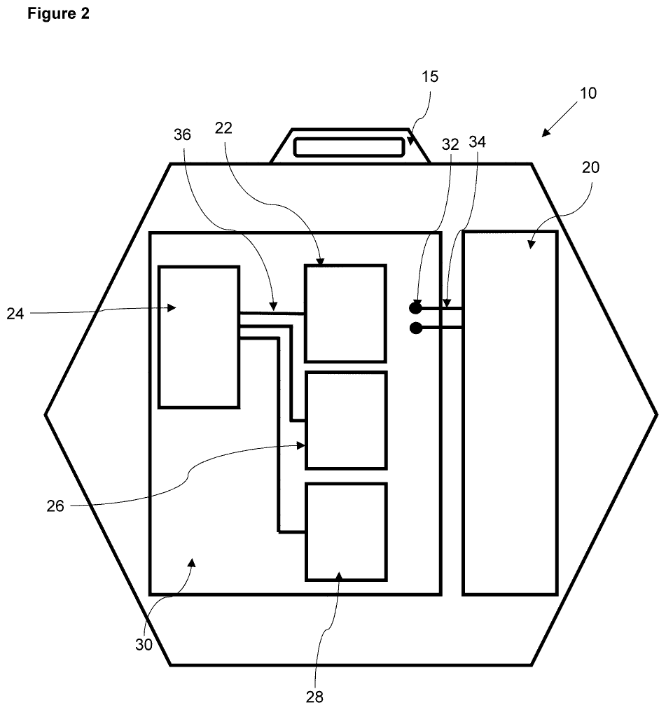

FIG. 2 shows a representation of internal electronic components of the personal contactless-tip-registering device of FIG. 1;

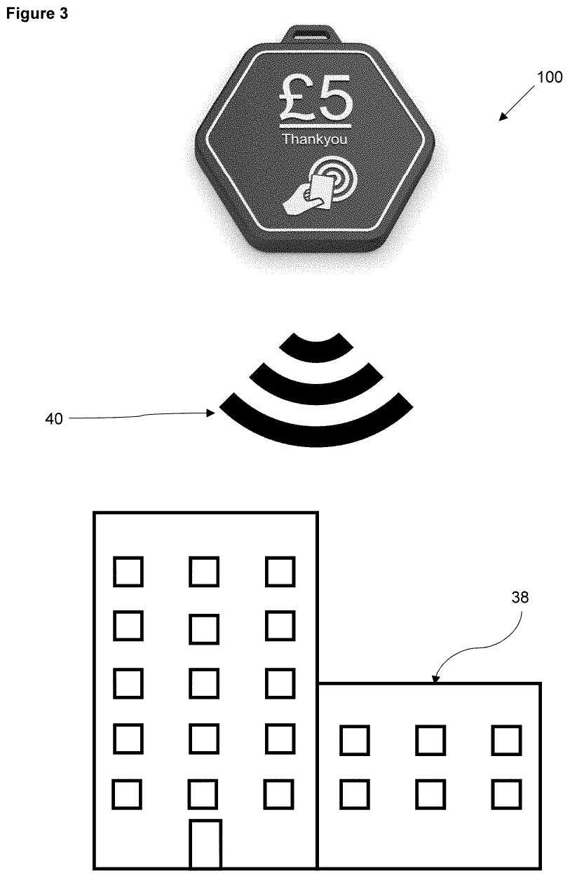

FIG. 3 shows a representation of a personal tip-registration system according to a second aspect of the invention; and

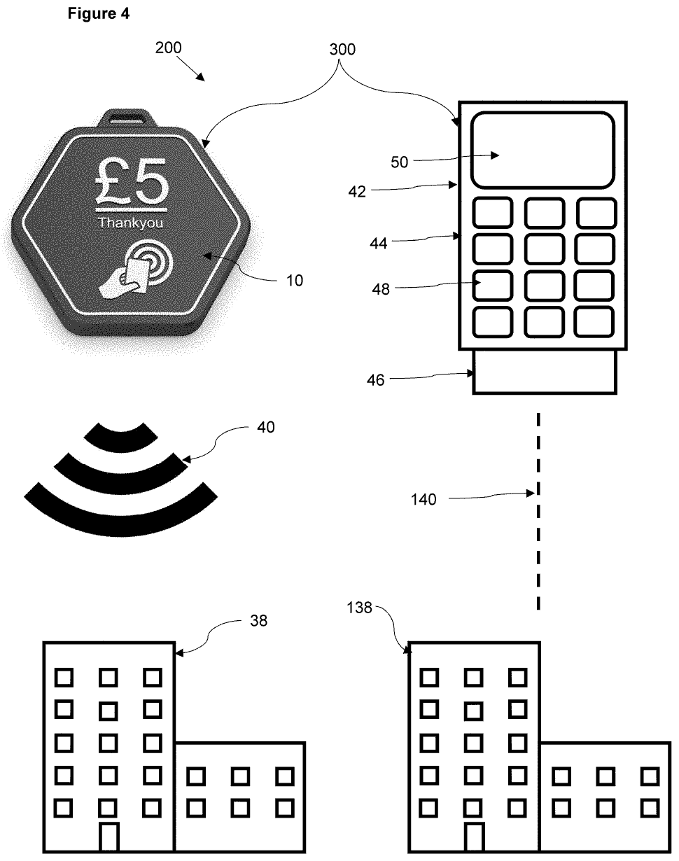

FIG. 4 shows a representation of a service payment and tipping system in accordance with a fifth aspect of the invention, including a service payment and tipping apparatus according to a fourth aspect of the invention.

Referring firstly to FIG. 1, there is shown a personal contactless-tip-registering device 10. Although described as a tip-registering device 10, it will be appreciated that the device may alternatively be described as a tip-receiving device or a tip-reading device.

The device 10 includes a body 12 and an indicator or indication element 14 and preferably further includes a user fastener or other attachment means 15.

The body 12 is preferably planar or substantially planar and/or may be considered to be thin or plate-like. The body 12 preferably has a diameter of less than or equal to 100 mm and the thickness of the body 12 is preferably less than or equal to 10 mm. As such, the device may be convenient to be carried by the user or service provider. Although described as being planar, it will be appreciated that this may not be the case. Furthermore, larger sizes may also be considered. Additionally, it will be appreciated than non-planar, non-thin and non-plate-like configurations may be considered. For example, the body 12 may be spherical or ovular.

The body 12 is hexagonal or substantially hexagonal, for example having hexagonal major surfaces. Although shown as hexagonal, it will be appreciated that other shapes may be considered such as rectangular or circular.

Plastics is used to form the body 12, although it will be appreciated that other materials may be considered.

The user fastener 15 is at or adjacent to the body 12 and is for releasably attaching the tip-registering device 10 to a service provider. Here the user fastener 15 is at an edge of the body 12, and is at an edge of the major surface of the body 12. However, it will be appreciated that the user fastener 15 may be at other locations, for example being in a central area of the major surface of the body 12.

The user fastener 15 here comprises a loop at an edge of the body 12 which defines an aperture or hole 16. The hole 16 may be used for connecting a clip or hook therethrough. The hook or clip may be secured to a lanyard, for example, and supported by the service provider's neck. Alternatively, the hook or clip may be a key chain or be secured to a service provider's belt. The hook or clip may be secured to an extensible and/or retractable cable or wire which may be attached to the user. This could allow the service provider to draw the device away from themselves and present the device to the customer whilst the device is still attached to the service provider.

Whilst a user fastener is preferable, it will be appreciated that it may not be included.

The indication element 14 is preferably on a major surface of the body 12. Here the indication is non-electrical or non-electronic, although it will be appreciated that electronic displays may also be considered. The indication element 14 is text, and indicates the tip amount, which will be better-understood hereinafter. The text is preferably embossed and is more preferably in contrasting colours or tones so as to be readily apparent. The height of the text, or font height, is preferably large, for example extending across at least 25% of the diameter of the body 12. This also allows the text to be readily apparent.

The body 12 has a black colour and the indication element 14 has a white colour, although it will be appreciated that these colours may be reversed or the body 12 and indication element 14 may have the same colour. Alternatively, the body 12 may have other colours for example green, yellow, orange, red, pink, purple or blue, with the indication element 14 having a black colour.

The major surface of the body 12 here also includes other representations 18, which includes an image 18a which represents contactless payment and text 18b which thanks the customer. However, it will be appreciated that such representations may not be included. A border 18c is also included.

Referring to FIG. 2, a representation of an interior of the tip-registering device 10 can be seen, including electronics. In other words, a front of the body 12 has been removed.

Although the front of the body 12 has been removed for illustration purposes, preferably the body 12 is not readily disassemblable, to prevent tampering. For example, the body 12 may be formed in two parts and then sealed around the internal electronics, using a heat seal or adhesive. Additionally or alternatively, the electronics may be secured with adhesive to a side of the body 12 having the indication element 14, so that an attempt to remove the electronics from the body 12 may result in destruction or disablement of the electronics.

The electronics or electricals of the tip-registering device 10 preferably includes a power source 20, and electronic wireless reader 22, a processor 24, a data storage device or element 26 and a wireless transmitter 28. The electronic wireless reader 22, processor 24, data storage element 26 and wireless transmitter 28 are preferably mounted to a printed circuit board 30 or similar, although other electronic mountings and configurations may be considered. Whilst described as being inside the body 12 of the device, it will be appreciated that the aforementioned electrical components may be at an edge or surface of the device.

The power source 20 is an on-board power source 20 by virtue of being at, on or in the device 10. The power source 20 is preferably a rechargeable battery, for example a lithium-ion battery. To facilitate recharging, the device 10 may include a port or socket at an edge of the body 12 and electrically connected to the rechargeable battery. In this way, a power plug or cable can be inserted into the port or socket to charge the battery. Alternatively, wireless charging may be considered. Whilst a rechargeable battery is described, it will be appreciated that a non-rechargeable battery may be included. If the batteries are intended to be replaceable, then an openable battery compartment in the body 12 may be provided to allow for replacement. Whilst batteries are described, a capacitor power source may also be envisaged.

The power source 20 is configured so as to power the electronic or electrical components, in other words the electronic wireless reader 22, processor 24, data storage element 26 and wireless transmitter 28. For example, the power source 20 is connected to power terminals 32 on the printed circuit board 30 via wiring 34 so as to power the components thereon. However, other connection arrangements may be considered. For example, it will be appreciated that the power source 20 may be mounted on the printed circuit board 30.

The power source 20 is preferably not external to the device, in other words, the power source 20 preferably does include external battery packs or direct mains power.

Whilst described as including a power source, the device may in fact only include a power source receiver, for receiving an on-board power source.

The electronic wireless reader 22 is for wirelessly reading contactless-payment-device data from a contactless payment device of the customer. The electronic wireless reader 22 may include a near field communication (NFC) reader, a radio-frequency identification (RFID) reader or other similar technology.

The data storage element 26, in other words a memory device, includes pre-set and non-adjustable tip data written thereon. The tip data includes a pre-set and non-adjustable tip amount to be paid by the contactless payment device. To prevent or limit adjustment of the non-adjustable tip data, the data storage element 26 is preferably read-only memory although other data locking techniques or technology may be considered.

The tip data and tip amount is therefore locked or fixed so that it cannot be adjusted by the user or other parties.

The wireless transmitter 28 is for transmitting tip data and contactless-payment-device data to an external payment processing system. The transmitter 28 may be an antenna. The external payment processing system may be a bank or other financial institution. It will be appreciated that the transmitter 28 may not communicate directly with the external payment processing system. For example, the transmitter 28 may be for communicating with a WiFi® network, and so may be a WiFi® antenna. Tip data and contactless-payment-device data may be sent via a wireless access point to the external payment processing system using the internet.

Alternatively, the transmitter 28 may be a mobile phone antenna for communicating with a mobile telephone network such as a mobile telephone base-station. The tip data and contactless-payment-device data may be sent via the mobile telephone network to the external payment processing system. The device 10 may also include a subscriber identity module, or SIM card, in the instance of a mobile phone antenna. Both a WiFi® antenna and mobile telephone network antenna may be considered.

The processor 24 is connected to and/or configured with the electronic wireless reader 22, data storage element 26 and wireless transmitter 28 so that when contactless-payment-device data is read by the electronic wireless reader 22, the transmitter 28 transmits the tip data and the contactless-payment-device data to the external payment processing system. The processor 24 may be programmed to achieve this. To connect the processor 24 to the electronic wireless reader 22, data storage element 26 and wireless transmitter 28, connections 36 are made, for example using the printed circuit board 30.

The tip amount as written on the data storage element 26 corresponds to the tip amount shown by the indication element 14.

The tip amount is here five pounds sterling, although other currencies may be considered such as US dollar, Euro, or Chinese Yuan. Other amounts may also be considered.

Referring to FIG. 3, a personal tip-registration system 100 is shown, including the personal contactless-tip-registering device 10 and the external payment processing system 38, connected by an at least partially wireless communicative connection 40. It will be understood that the connection may only be wireless between the device and a WiFi® access point or a mobile phone base station. The personal tip-registration system 100 also includes a personal bank account belonging to the service provider employee which is communicative with the external payment processing system 38. The bank account may, for example, be at the external payment processing system 38. The external payment processing system 38 is configured to deposit or instruct the deposition of the or each tip amount registered by the personal contactless-tip-registering device 10 directly into the personal bank account.

In use, the service provider employee is provided with the personal contactless-tip-registering device 10. The personal contactless-tip-registering device 10 may be programmed or pre-programmed with an employee's bank account details, for example.

Alternatively, the personal contactless-tip-registering device 10 may include an identifier, such as a code, and the service provider may register their bank account details with the identifier at the external payment processing system 38. The employee's bank account details or the identifier may be stored on the data storage element 26, for example. The service provider employee may have selected the personal contactless-tip-registering device 10 with the desired tip amount indicated thereon and pre-programmed to the data storage element 26.

The service provider employee may attach the personal contactless-tip-registering device 10 to an article of clothing, for example to a lanyard or belt, via the fastener 15.

When a customer desires to provide a tip to the service provider via a contactless payment device, the service provider would present the tip-registering device 10 to the customer, ensuring the indication element 14 is visible. The customer would present their contactless payment device to the tip-registering device 10, for example by bringing the contactless payment device into close proximity with the tip-registering device 10. The electronic wireless reader 22 would detect and read contactless-payment-device data from the contactless payment device. For example, the electronic wireless reader 22 would read card details or other identifiers therefrom.

The processor 24, would then instruct the transmitter 28 to transmit the contactless-payment-device data and the non-adjustable tip data to the external payment processing system 38. This data may also be accompanied by the employee's bank account details or the identifier. The external payment processing system 38 may then directly deposit the tip amount into the employee's bank account, and debit the customer's bank, credit or payment account.

Referring now to FIG. 4, there is shown a service payment and tipping system 200 including a service payment and tipping apparatus 300. The service payment and tipping apparatus 300 includes the aforementioned personal contactless-tip-registering device 10 along with a payment-registering device 42. The contactless-tip-registering device 10 is for receiving a tip for the employee as described previously, whilst the payment-registering device 42 is for receiving a payment for the service for the employer.

The payment-registering device 42 may include a further body 44, a further electronic reader, a further processor, a further data storage element, and a communication means or communicator.

The electronic reader may be a contactless reader and therefore may function in a similar or identical way to the reader 22 of the tip-registering device 10. Alternatively the reader may be contact smart card reader or a reader for magnetic strip cards. A contact smart card 46 is here shown being read.

The further data storage element may be a memory device for receiving payment data which specifies a payment amount to be paid by the contactless payment device. Such payment data may be inputted by the service provider, and thus the memory device may be writable and rewritable. The payment-registering device 42 may include buttons 48 and/or a screen 50 for this purpose.

The communication means is for communicating payment data and payment-device data to an external payment processing system 138. The communication means may be a wireless transmitter, as previously described for the tip-registering device 10. However, it will be appreciated that the communication means may include a port for connecting communication wires.

The further processor is connected to the further electronic reader and communication means so that when payment-device data is read by the electronic reader, the communication means transmits the payment data and the payment-device data to the external payment processing system 138.

The payment-registering device 42 may preferably include an on-board power source, such as a battery. However, it will be appreciated that the payment-registering device 42 may alternatively have a wired power connection from the mains.

The service payment and tipping system as shown in FIG. 4 comprises the service payment and tipping apparatus 300 and first and second external payment processing systems 38, 138. The first external payment processing system 38 is communicatively connected to the personal contactless-tip-registering device 10 via a connection 40 which is at least in part wireless. The payment-registering device 42 is communicatively connected to the second external payment processing system 138 by a connection 140 which may be at least in part wireless, or may be entirely wired. It will be appreciated that the two devices 10, 42 of the apparatus 300 may be connected or communicate with the same external payment processing system 38.

The service payment and tipping system 300 further comprises a bank account belonging to the employee, which is preferably a personal bank account, and communicative with the first external payment processing system 38. The service payment and tipping system 300 additionally includes a bank account belonging to the employer, which is preferably a company bank account, and communicative with the second external payment processing system 138.

The first external payment processing system 38 is configured to deposit the tip amounts registered by the personal contactless-tip-registering device 10 directly into the personal bank account. In other words, each tip amount is not first received by the employer before being sent to the employee. The second external payment processing system 138 is configured to deposit at least one payment amount registered by the payment-registering device 42 directly into the company bank account.

In this way, the customer can pay for the service, as well as providing a tip, quickly and efficiently whilst reassured that the employee will directly receive the tip without interference from the employer.

In use, the employee service provider is provided the service payment and tipping apparatus 300.

When a customer desires to pay via a payment device, the employee may present the payment-registering device 42 to the customer of the employee. The payment-registering device 42 would read payment-device data from the payment device and communicate the payment-device data, and payment data which specifies a payment amount, to an external payment processing system 138. The reading of the payment-device data may be contactless, via a contact smart card reader 22 or via a reader 22 for magnetic strip cards. The payment-registering device 42 may also communicate the details of the bank account of the employer and/or an identifier in the same way as described as for the tip-registering device.

The external payment processing system 138 may then directly deposit the payment amount in the company bank account belonging to the employer. The bank, payment or credit account of the customer may be appropriately debited.

The service provider may then present the tip-registering device 10 to the customer of the service provider, the payment device being contactless or the customer having a contactless payment device.

The tip-registering device 10 may then read contactless-payment-device data from the contactless payment device and transmit the contactless-payment-device data and pre-set tip data which specifies a pre-set tip amount to an external payment processing system 38. The external payment processing system 38 directly deposits the pre-set tip amount in a bank account belonging to the service provider. The bank, payment or credit account of the customer may be appropriately debited.

A further tip registration system may also be provided, having a plurality of the aforementioned tip-registering devices. The tip registering devices preferably having differing tip amounts, the tip amount of the non-adjustable tip data matching the tip amount of the indication element. For example, there may be a tip registration system of tip-registering devices having respective tip amounts of £1, £2, £3, £5, £10, £15, £20, £30, £40. Other currencies may also be considered and it will be appreciated that based on local contactless payment amount limit laws and tipping customs, different values may be considered. A user may select the tip-registering device which has the tip amount which corresponds to the amount they may expect to be tipped, which may depend upon the amount a customer may pay for the service and the tipping culture of the locality and type of establishment. The user may select multiple tip-registering devices to provide tipping amount options from which the customer may select.

In some instances, the tip-registering device may also include location determining element. For example, a global positioning system receiver. In this instance, the data storage element would include location data, the location data being the location of the premises where the tip-registering device is authorised to be used. For example, the location surrounding the premises of a restaurant. The processor may only transmit contactless-payment-device data if the location determining element determines the location of the device is according to the location data.

Although not shown, in the instance of rechargeable batteries, the device may include a low battery light, such as a light emitting diode, and associated circuitry to indicate when the rechargeable battery requires charging.

Additionally or alternatively, the device may include an indication light, such as a light emitting diode, configured to emit a light when a tip is registered. The low battery light and the indication light may be one and the same. It will be appreciated that the device may even include multiple different coloured lights. For example, the device may include a green light for indicating successful registration of the tip, or a red light for indicating non-successful registration, such as if the payment device is decline.

Although not shown, the tip-registering device may include a speaker or other noise emitter for emitting a noise when contactless-payment-device data is read, transmitted and/or a tip is registered. If the device includes a rechargeable battery, the speaker could be configured to emit a noise when the rechargeable battery requires charging.

The tip-registering device may include a further memory device for recording contactless-payment-device data. Multiple data entries may then be submitted by the transmitter as a batch.

Although a transmitter is described for the tip-registering device, the device may in fact not include a transmitter. The device may instead record contactless-payment-device data on a memory device. The device may be manually connected to a further device for wired or wireless communication of stored contactless-payment-device data to the external payment processing system.

Whilst described as being non-adjustable, it will be appreciated that the tip data and amount may in fact be adjustable.

Whilst described as being for an employee, it will be appreciated that self-employed service providers may use the tip-registering device.

Although no user controls are shown, it will be appreciated that the device may include an on-off switch for enabling or disabling the power supply to the electronics.

It is therefore possible to provide a contactless and portable tipping device having a fixed tipping value. The tipping device is linked to the user's bank account, so that when a tip is registered the tip amount is automatically deposited in the user's bank account, without having to be redistributed from an employer's or company bank account, for example. This is more convenient for an employer, as well as giving confidence to the customer that the tip will be received by the employee.

The words ‘comprises/comprising’ and the words ‘having/including’ when used herein with reference to the present invention are used to specify the presence of stated features, integers, steps or components, but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of examples only, and various other modifications will be apparent to persons skilled in the field without departing from the scope of the invention as defined herein.

1. A personal contactless-tip-registering device for registering a contactless tip via a contactless payment device, the tip-registering device comprising:
a body;
a user fastener at the body for releasably attaching the tip-registering device to a service provider;
an on-board power source being any one of at and in the body;
an electronic wireless reader being any one of at and in the body for wirelessly reading contactless-payment-device data from the contactless payment device;
a processor being any one of at and in the body;
a data storage device being any one of at and in the body including pre-set and non-adjustable tip data which specifies a pre-set and non-adjustable tip amount to be paid by the contactless payment device;
a wireless transmitter being any one of at and in the body for transmitting tip data and contactless-payment-device data to an external payment processing system; and
an indicator on the body which indicates the pre-set tip amount;
the power source configured to power the electronic wireless reader, processor, data storage device, and wireless transmitter, and the processor connected to the electronic wireless reader, data storage device and wireless transmitter so that when contactless-payment-device data is read by the electronic wireless reader, the transmitter transmits the tip data and the contactless-payment-device data to the external payment processing system.

2. The personal contactless-tip-registering device as claimed in claim 1, wherein the device does not comprise at least any one of an electrical screen, microphone and a button.

3. The personal contactless-tip-registering device as claimed in claim 2, wherein the device does not comprise any of an electrical screen, microphone and a button.

4. The personal contactless-tip-registering device as claimed in claim 1, wherein the indicator is non-electrical.

5. The personal contactless-tip-registering device as claimed in claim 4, wherein the indicator is embossed text.

6. The personal contactless-tip-registering device as claimed in claim 4, wherein the indicator is text and a height of the text may be no less than 25% of a diameter of the body.

7. The personal contactless-tip-registering device as claimed in claim 1, wherein the transmitter is for communicating with a WiFi® network.

8. The personal contactless-tip-registering device as claimed in claim 1, wherein the transmitter is for communicating with a mobile telephone network.

9. The personal contactless-tip-registering device as claimed in claim 1, wherein the user fastener comprises any one of a hole and a closed loop for connecting any one of a clip and hook therethrough.

10. The personal contactless-tip-registering device as claimed in claim 1, wherein the body has a diameter of no more than 100 mm.

11. The personal contactless-tip-registering device as claimed in claim 1, wherein the body is substantially planar.

12. The personal contactless-tip-registering device as claimed in claim 1, wherein the body has a thickness of no more than 10 mm.

13. The personal contactless-tip-registering device as claimed in claim 1, wherein the pre-set tip amount is any one of 5 USD, 5 GBP, 5 EUR and 50 RMB.

14. The personal contactless-tip-registering device as claimed in claim 1, further comprising a receiver of a positioning system, the data storage device including location data, the processor transmitting contactless-payment-device data only if the receiver of the positioning system determines the location of the device is according to the location data.

15. A personal tip-registration system for registering a tip for a service provider, the system comprising:
the personal contactless-tip-registering device as claimed in claim 1;
an external payment processing system communicatively connected to the personal contactless-tip-registering device; and
a personal bank account belonging to the service provider and communicative with the external payment processing system;
the external payment processing system configured to deposit at least one tip amount registered by the personal contactless-tip-registering device directly into the personal bank account.

16. A method of directly tipping a service provider via a contactless payment, the method comprising the steps of:
providing a service provider with the personal contactless-tip-registering device as claimed in claim 1 and attaching the tip-registering device to the service provider;
the service provider presenting the tip-registering device to a customer of the service provider, the customer having a contactless payment device;
the tip-registering device reading contactless-payment-device data from the contactless payment device and transmitting the contactless-payment-device data and pre-set tip data which specifies a pre-set tip amount to an external payment processing system;
the external payment processing system directly depositing the pre-set tip amount in a bank account belonging to the service provider.

17. A service payment and tipping apparatus for registering payment directly to an employer and registering a contactless tip directly to an employee, the apparatus comprising:
the personal contactless-tip-registering device as claimed in claim 1; and
a payment-registering device including a further body, a further electronic reader being any one of at and in the body for reading payment-device data from a payment device; a further processor being any one of at and in the body; a further data storage device being any one of at and in the body for receiving payment data which specifies a payment amount to be paid by the payment device; at least one of a wired communication connection and a wireless transmitter being any one of at and in the body for communicating payment data and payment-device data to an external payment processing system; the further processor connected to the further electronic reader and said at least one of a wired communication connection and a wireless transmitter so that when payment-device data is read by the electronic reader, the said at least one of a wired communication connection and a wireless transmitter transmits the payment data and the payment-device data to the external payment processing system.

18. A service payment and tipping system for registering payment directly to an employer and registering a contactless tip directly to an employee, the system comprising:
the service payment and tipping apparatus as claimed in claim 17;
an external payment processing system communicatively connected to the personal contactless-tip-registering device;
the payment-registering device communicatively connected to any one of the and another external payment processing system;
a personal bank account belonging to the employee and communicative with the external payment processing system;
a company bank account belonging to the employer and communicative with said any one of the and another external payment processing system;
the external payment processing system configured to deposit at least one tip amount registered by the personal contactless-tip-registering device directly into the personal bank account; and
said any one of the and another external payment processing system configured to deposit at least one payment amount registered by the payment-registering device directly into the company bank account.

19. A method of directly tipping a service provider via a contactless payment and directly paying an employer, the method comprising the steps of:
providing a service provider with the service payment and tipping apparatus as claimed in claim 17 and attaching the tip-registering device to the employee;
the employee presenting the payment-registering device to a customer of the employee, the customer having a payment device;
the payment-registering device reading payment-device data from the payment device and communicating the payment-device data and payment data which specifies a payment amount to an external payment processing system;
the external payment processing system directly depositing the payment amount in a bank account belonging to the employer;
the service provider presenting the tip-registering device to a customer of the service provider, the customer having a contactless payment device;
the tip-registering device reading contactless-payment-device data from the contactless payment device and transmitting the contactless-payment-device data and pre-set tip data which specifies a pre-set tip amount to an external payment processing system; and
the external payment processing system directly depositing the pre-set tip amount in a bank account belonging to the service provider.

20. A personal tip registration system comprising a plurality of the personal contactless-tip-registering devices as claimed in claim 1, each of the personal contactless-tip-registering devices having a different pre-set tip amount.
